(19) United States
(12) Patent Application Publication
(10) Pub. No.: US 2026/0141195 A1
(43) Pub. Date: May 21, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TOMOHIRO NISHIYAMA, Tokyo (JP)

(21) Appl. No.: 19/384,090

(22) Filed: Nov. 10, 2025

(30) Foreign Application Priority Data
Nov. 15, 2024 (JP) 2024-199849

(51) Int. Cl. G06K 7/14

(52) U.S. Cl. CPC G06K 7/1417

(57) ABSTRACT

An information processing apparatus includes at least one memory storing instructions, and at least one processor executing the stored instructions causing the information processing apparatus to: set setting areas including subjects in an image; detect codes that have been allocated to the subjects; acquire first information corresponding to the codes; acquire second information corresponding to images within the setting areas; perform correspondence of the codes and the setting areas by comparing the first information and the second information; and output at least one of the first information and the second information based on the results of the correspondence.

### BACKGROUND

### Field of the Technology

The present disclosure relates to a technology for acquiring information for a subject to be made a target.

### Description of the Related Art

A technology that robustly displays information with a high precision for a subject that is of interest to a user on a screen displayed on a camera, a smartphone, smart glass, and the like makes it possible to search for this information on the spot, and in addition there is an increasing need for such a technology in systems for payment and the like.

Japanese Unexamined Patent Application, First Publication No. 2014-85757 discloses a technology that reads information for an IC tag that has been embedded into a product using a mobile terminal, and downloads information for the product from a server based on the information for the IC tag. In addition, a technology that identifies a subject in an image by using machine learning is also known.

However, in the method that is disclosed in Japanese Unexamined Patent Application, First Publication No. 2014-85757, in a case in which there are a plurality of adjacent subjects, there is a need for the user to bring the mobile terminal closer to the subject that will become the target in order to designate it. In addition, although as a different method, a method is known that acquires the information for the subject by using image recognition, there is a possibility that the information will not be able to be correctly acquired due to the angle of view and illumination conditions at the time of the image capturing. In addition, in the case of such a method that acquires information for a subject by image recognition, there are cases in which the recognition precision is lowered due to the learning for subjects for which it is difficult to obtain images for use in learning.

### SUMMARY

The present disclosure is directed to provide an information processing apparatus, information processing method, and a storage medium that are able to acquire information robustly and with a high precision for a subject that will become a target.

According to an aspect of the present disclosure, an information processing apparatus includes at least one memory storing instructions; and at least one processor executing the stored instructions causing the information processing apparatus to: set setting areas including subjects in an image; detect codes that have been allocated to the subjects; acquire first information corresponding to the codes; acquire second information corresponding to images within the setting areas; perform correspondence of the codes and the setting areas by comparing the first information and the second information; and output at least one of the first information and the second information based on the results of the correspondence.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram for an information processing apparatus according to the First Embodiment.

FIG. 2 is a flowchart according to an operation of the information processing apparatus that has been shown in FIG. 1.

FIG. 3 is a schematic diagram of codes.

FIG. 4 is an explanatory diagram for processing for an information comparison unit that has been shown in FIG. 1.

FIG. 5A, and FIG. 5B are explanatory diagrams for processing for an information processing apparatus according to the Second Embodiment.

FIG. 6 is an explanatory diagram for processing for an information processing apparatus according to a Third Embodiment.

FIG. 7 is an explanatory diagram for processing for an information processing apparatus according to a Fourth Embodiment.

### DESCRIPTION OF THE EMBODIMENTS

Below, embodiments of the present disclosure will be explained with reference to the attached figures.

### First Embodiment

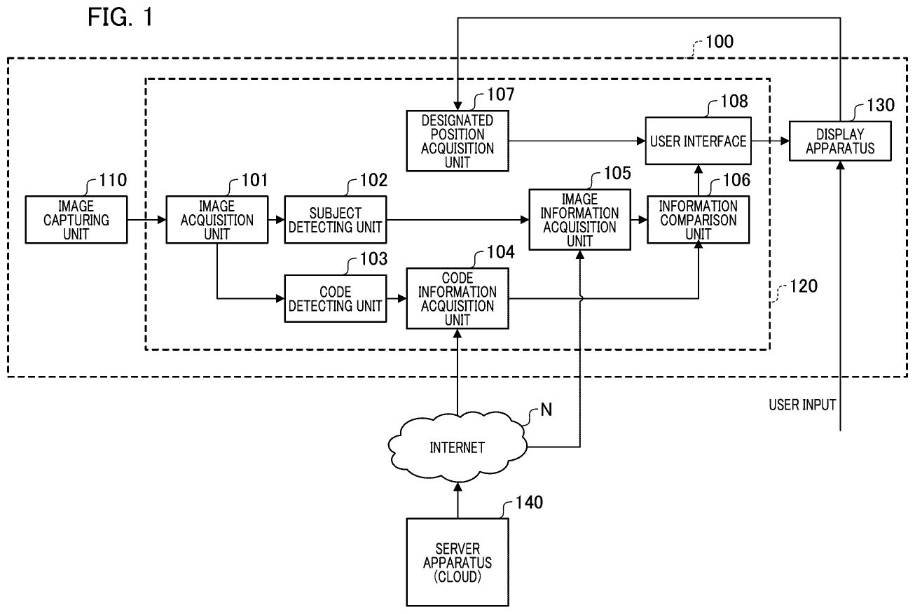

FIG. 1 is a block diagram showing a configurational example of an information processing apparatus 100 in a First Embodiment of the present disclosure. The information processing apparatus 100 has an image capturing unit 110, a processing unit 120, and a display unit 130. In addition, the processing unit 120 has an image acquisition unit 101, a subject detecting unit 102, a code detecting unit 103, a code information acquisition unit 104, an image information acquisition unit 105, an information comparison unit 106, a designated position acquisition unit 107, and a user interface 108. The information processing apparatus 100 is able to acquire information from a server apparatus 140 via an internet N as one example of an external network.

The image capturing unit 110 acquires images of targets. Although a digital camera, a smartphone, smart glass, and the like are given as examples of the image capturing unit 110, the present disclosure is not limited thereto, and it is sufficient if the image capturing unit 110 is a device that is able to acquire images. The processing unit 120 functions as a key component of the information processing apparatus 100. The display unit 130 functions as a display unit that displays information, and may be one portion of the image capturing unit 110, and may also be a mode that performs display on a display that is separate from the image capturing unit 110. Note that, it is sufficient if the information processing apparatus 100 is able to realize at least the functions of each block of the processing unit 120 that will be described below.

The image acquisition unit 101 acquires images that have been acquired by the image capturing unit 110. The subject detecting unit 102 detects an area that includes each subject included in the image (referred to below as a subject area) as a box for a rectangular area based on the image that has been acquired by the image acquisition unit 101. A method based on machine learning is given as an example of the method for detecting the subject area. Specifically, an example is given in which a convolutional neural network and a transformer are used as the subject detecting unit. However, the method is not limited to machine learning as long as it is a method that is able to detect a subject. In addition, the box for the subject area does not need to be rectangular, and for example, segmentation may also be performed for each subject.

That is, the subject detecting unit 102 functions as a second detecting unit configured to detect a subject area. Furthermore, the subject detecting unit 102 functions as an area setting unit configured to set a subject area as a setting area.

The code detecting unit 103 detects a code that has been physically allocated to a subject. The details of the codes will be explained below. That is, the code detecting unit 103 functions as a first detecting unit configured to detect a code that has been allocated to a subject.

The code information acquisition unit 104 acquires information relating to a subject that is included in the code itself that has been detected by the code detecting unit 103. Conversely, the code information acquisition unit 104 acquires information relating to the subject from the server apparatus 140 via the internet N based on information such as a link that has been included in the code, and the like. That is, the code information acquisition unit 104 functions as a first information acquisition unit configured to acquire information corresponding to a code (code information).

The image information acquisition unit 105 performs recognition on the image of the subject area based on the subject area that was acquired by the subject detecting unit 102, and acquires information relating to subject as recognition results. Conversely, the image information acquisition unit 105 acquires information for the subject from the server apparatus 140 via the internet N based on results of having performed recognition on the image of the subject area. That is, the image information acquisition unit 105 functions as a second information acquisition unit configured to acquire information corresponding to an image of inside of a setting area (image information).

The information comparison unit 106 performs correspondence of the code that has been detected with the subject area based on the results of comparing the information that has been acquired by the code information acquisition unit 104 and the information that has been acquired by the image information acquisition unit 105. The details of the correspondence will be explained below. That is, the information comparison unit 106 functions as an information comparison unit configured to perform correspondence of a code with a setting area by comparing first information and second information.

The designated position acquisition unit 107 acquires a user designated position within an image. In the present embodiment, it is made such that the display unit 130 has a touch panel function, and the user inputs are performed via the touch panel. The designated position acquisition unit 107 acquires information for a position that the user has touched with a finger, and the like on the touch panel. That is, the designated position acquisition unit 107 functions as a designated position acquisition unit configured to acquire a position that a user has designated within an image.

Note that in a case in which the image capturing unit 110 is a smart glass, and the like, it may also be made such that this is provided with a sensor that performs acquisition by detecting a line of sight position for the user on the screen, and the user designated position is acquired by the line of sight. That is, the sensor functions as a line of sight detecting unit configured to detect a user's line of sight, and the position may also be acquired based on the line of sight that has been detected. That is, the acquisition method for the user designated position is not limited to the method described above as long as it is a method that is able to specify a certain subject position that is of interest to the user.

In a case in which there are adjacent subjects, there are cases in which a plurality of codes exist in the vicinity of the user designated position and it is difficult to determine which code the user is specifying. Therefore, as will be explained below, it becomes possible for the user to designate a subject that will become a target in a manner that is visually easy to understand by the information comparison unit 106 performing correspondence of the code with the subject area.

The user interface 108 specifies the subject area that is the closest to the user designated position, and outputs at least one of the code information and the image information, for which correspondence has been performed by the information comparison unit 106, to the display unit 130, and thereby displays this. That is, the user interface 108 functions as an output unit configured to output at least one of first information and second information based on results from an information comparison unit.

When display is performed to the display unit 130, examples of variations are given such a display in which information corresponding to the user designated position is enlarged, a display in which the colors have been changed, a display in which the size of the characters has been changed, and the like. Note that as long as the information for the user designated position is displayed on the display unit 130 in a format in which this can be distinguished from other information, the display method is not limited to the above-described methods.

Above, an explanation has been given of an example in which the user designates the designated position in advance. However, the subject area and corresponding information may also be displayed on the display unit 130 first, and the user may also select a display location. Conversely, it may also be made such that just the subject area (setting area) is displayed first, and after this, the information for the subject area that the user has selected is displayed. That is, the user interface 108 may also display information for which correspondence has been performed with the subject area that corresponds to the user designated position that has been acquired. In addition, it may also be made such that in a case in which the subject area that has been detected is below a predetermined threshold value, just the subject area is displayed first. By presenting to the user that the selection range has been limited in advance, it becomes possible to prevent the user from designating positions that cannot be selected such as, for example, a subject for which the subject area could not be detected, and the like. (processing flow)

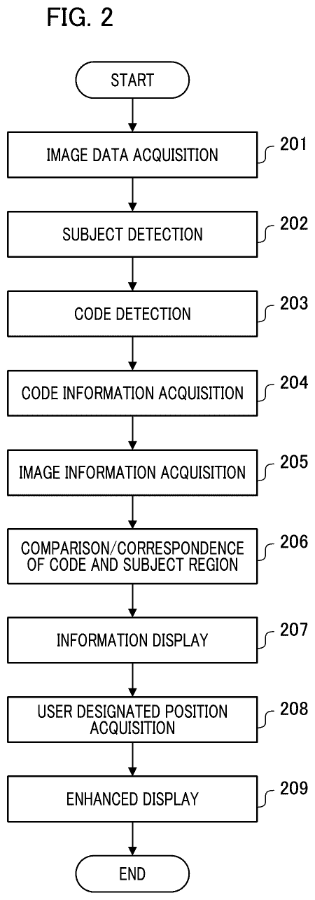

The flow of the processing in the present embodiment will be explained with reference to FIG. 2. FIG. 2 is a flowchart showing one example of processing (an information processing method).

First, during step 201, the image acquisition unit 101 acquires an image from the image capturing unit 110. Next, during step 202, the subject detecting unit 102 detects a subject area from the image that was acquired by the image acquisition unit 101. Next, during step 203, the code detecting unit 103 detects a code that is included in the image. Next, during step 204, the code detecting unit 103 acquires code information that is included in the code that was detected during step 203, and downloads information by accessing the server apparatus 140 based on the code information that has been acquired. Note that it may also be made such that the server 140 is not accessed, and the code information itself is output.

Next, during step 205, the image information acquisition unit 105 performs image recognition within the subject area that was detected by the subject detecting unit 102, and downloads information (image information) by accessing the server apparatus 140 based on the recognition results. Note that it may also be made such that the server apparatus 140 is not accessed, and the image recognition results themselves are output.

In addition, step 202 to step 205 are not limited to being executed in the above-described order. Although it is necessary that step 202 is executed before step 205, and that step 203 is executed before step 204, step 202 and step 203 may also be executed parallelly, and step 204 and step 205 may also be executed parallelly.

Next, during step 206, the information comparison unit 106 performs matching of the code information that was acquired by the code information acquisition unit 104, and the image information that was acquired by the image information acquisition unit 105, and performs correspondence of the subject area and the code. Next, during step 207, the user interface 108 performs display of information for each subject on the display unit 130 based on the results of the information comparison unit 106. Display of the codes and subject areas for which correspondence was not performed during step 206 may also be performed based on the information for the code separately (code information), and information for the subject area separately (image information).

Next, during step 208, the designated position acquisition unit 107 acquires the user designated position. In addition, during step 209, the user interface 108 enlarges the information corresponding to the subject area that is the closest to the user designated position, and the detection box for the subject, and thereby displays this to the user on the display unit 130. That is, the user interface 108 functions as a display control unit configured to display at least one of first information and second information based on a position that has been acquired by the designated position acquisition unit.

According to the flowchart in FIG. 2, step 202 functions as an area setting step, step 203 functions as a first detection step, and step 204 functions as a first information acquisition step. In addition, step 205 functions as a second information acquisition step, step 206 functions as an information comparison step, and step 207 functions as an output step. In addition, each step of the flowchart in FIG. 2 may also be configured as a program that is executed by a CPU.

Note that in FIG. 2, although the information for each subject (code information, image information), was displayed before the user designated a position the information for subjects in the vicinity of the designated position may also be displayed after the user has designated the designated position. (Codes)

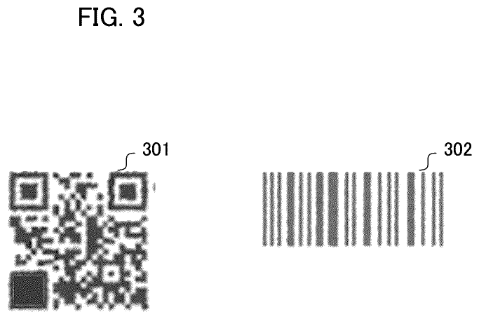

Next, the codes will be explained with reference to FIG. 3. FIG. 3 shows a schematic diagram of the codes. 301, and 302 both show examples of two-dimensional codes. 301 shows an example of a QR code (registered trademark), and 302 shows an example of a barcode. Although 301, and 302 are able to be recognized (read) under visible light, the same pattern but able to be recognized (read) under non-visible light may also be embedded into the subject in order to not negatively affect the appearance of the subject. In this case, the image capturing unit 110 is made to be provided with an image capturing element that is able to detect non-visible light. In a case in which the size of the code is small, the image may also be segmented into each area, and the codes may be detected after having enlarged the areas.

A three-dimensional pattern may also be used as the code, in addition to 2-dimensional codes such as 301, and 302. In addition, this may also be a tag that is an object that is removable from the subject and transmits electromagnetic waves itself such as an RF tag (IC tag). Conversely, this may also be a mode such an RFID (Radio Frequency Identification) system in which electromagnetic waves are transmitted from the information processing apparatus 100, and the system operates based on the energy from these electromagnetic waves. Furthermore, two or more of these modes may also be combined. That is, it is sufficient if the code of the present embodiment is a medium that is physically allocated to the subject, and includes information that can identify a product and the like that becomes a subject, link information for information that can identify a product and the like that becomes a subject, and the like.

The number of codes that are allocated to a subject is not limited to one code, and as will be explained below, in consideration of cases in which the subjects overlap and are hidden, a plurality of the same code may also be allocated to the same subject. In addition, in the same manner as the RF tag that was explained above, the code may also be embedded into a tag that has been attached to the subject and the like, instead of to the subject itself. (Information comparison unit)

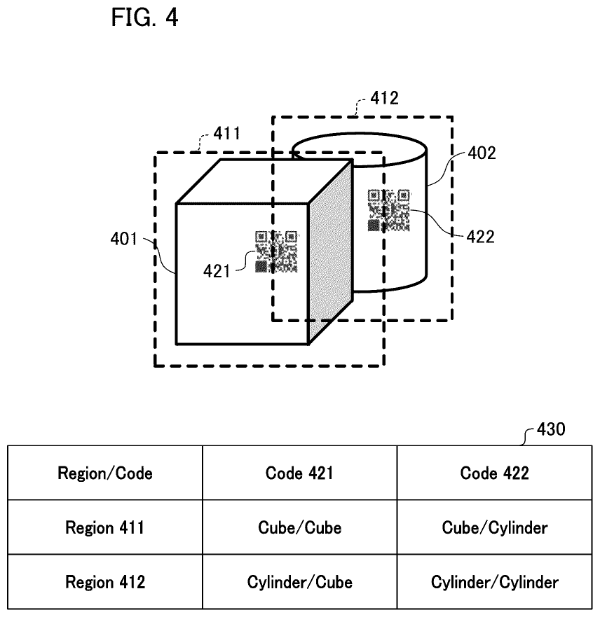

Next, the operations of the information comparison unit 106 will be explained with reference to FIG. 4. The benefit of using the code by performing comparison with image recognition is that if the code can be detected, it is possible to reliably acquire the information. However, in a case such as a downtown area, inside of a shop, and the like, in which the subjects are in close proximity to each other, the need to perform correspondence of which code has been allocated to which subject arises. Therefore, the information comparison unit 106 performs correspondence of the codes and the subject areas.

FIG. 4 extracts a portion of and schematically shows a state in which the subjects are in close proximity with each other. In reality, although there are many cases in which subjects other than those shown exist, for the convenience of the figures, these have been omitted. In FIGS. 4, 411 shows the subject area corresponding to the subject 401, and 412 shows the subject area corresponding to the subject 402. In addition, the code 421 has been allocated to the subject 401, and the code 422 has been allocated to the subject 402.

A portion of the code corresponding to the subject 401 is also included in the subject area 412, and therefore, it is necessary to correctly perform the correspondence of each subject area with each code. The table 430 shows the subject areas (areas) and codes in a matrix form, and each cell that configures the table has the image information within the area written on the left side and the code information written on the right side. For example, in the cell in which the “area 411” and the “code 422” intersect, it is shown that the image information is a “cube”, and the code information for the code 422 is a “cylinder”.

Although only the shape of subject has been disclosure in order to simplify the table 430, this may also include a plurality of pieces of information relating to the color, the material, and the characteristics of the subject, as well as complex information such as an explanatory text, an image, a shape, and the like relating to the subject. When performing matching of the information, a method such as converting the information into feature vectors and measuring the distance between the feature vectors may also be used. The information comparison unit 106 matches the image information and the code information within the subject area. In the case of the table 430, the combinations in which the image information and the code information match each other of the top left cell and the bottom right cell are used, and correspondence is performed for the subject areas and the codes. That is, correspondence is performed for the subject area 411 and the code 421, which are the combination from the upper left cell, and correspondence is performed for the subject area 412 and the code 422, which are the combination from the bottom right cell.

Although an example has been explained above in which it is possible to perform correspondence of the codes and the subject areas, for example, in a case in which a code in a subject area is hidden and cannot be detected, and a case in which a subject cannot be recognized in the image, the code may be handled independently, and the subject area may be handled independently without performing correspondence.

In this manner, by associating and using image recognition and a code that has been embedded into a subject, it is possible to obtain information robustly and with a high precision for a target subject that is of interest to the user.

### Second Embodiment

In the present embodiment, an explanation will be given of a case in which the code information is used as supplementary information at the time of detection, recognition, and display of an image. Note that explanations of the configurations that are the same as the configurations in the First Embodiment will be omitted, and below, an explanation will be given that focuses on the portions that are different from the First Embodiment.

In FIG. 4 a portion of the subject 402 is hidden by the subject 401, and therefore, there is a possibility that the precision of the image detection and recognition will decrease. At this time, if the code 422 is detected, it is possible for the code information acquisition unit 104 to acquire the information for the subject 402, and therefore, it is possible for the subject detection unit 102 and the image information acquisition unit 105 to perform image recognition and acquisition of the subject information by supplementarily using the code information for the code 422. For example, if information such as the shape, color, and the like of the subject 402 has been embedded in the code 422, then it becomes possible to increase the precision of the subject detection and recognition by using this information. That is, the subject detecting unit 102 may also detect the subject area based on the first information.

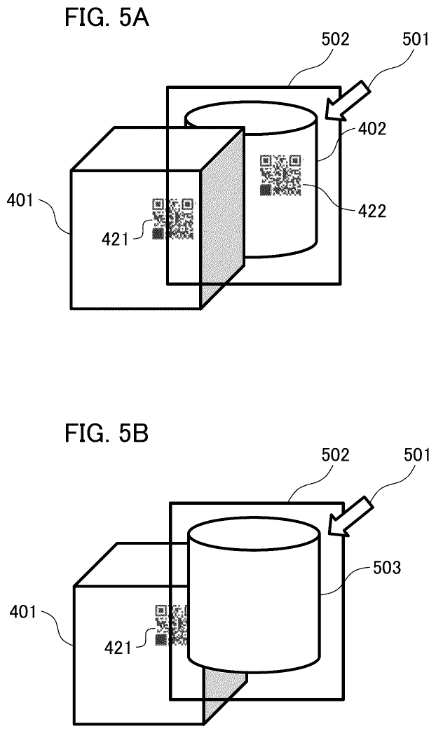

In addition, if a link to image information for the entire subject 402 and 3-dimensional shape information is included in the code 422, then the information may also be acquired and displayed on the display unit 130 based on this link. An example thereof will be explained using FIG. 5A, and FIG. 5B. In FIGS. 5A, 501 is the user designated position that has been acquired by the designated position acquisition unit 107. 502 shows an enhanced display of the closest subject detection box based on the position of 501. By doing so, it is possible to perform the display such that it is easy for the user to understand which subject they have designated.

FIG. 5B is an example in which, as is shown in FIG. 5A, an image of the subject 402 (external appearance information) has been downloaded from, for example, the server apparatus 140 based on the information for the code 422, and this has been displayed as superimposed on the subject 402 in the user designated position. 503 is the image that has been downloaded, and it is made such that it is possible to see the hidden portion of the subject 402 in the image 503. Note that even if there is no user designation, the subject information from the image that has been acquired by the image acquisition unit 101 and the information that has been downloaded by the image information acquisition unit 105 may be compared, and an occlusion determination may be performed by the image information acquisition unit 105. In addition, in a case in which it has been determined that there is an occlusion, a superimposed display may also be automatically performed on the user interface 108.

In addition, the information that is downloaded is not limited to an image of the subject (appearance information), and 3-dimensional shape information for the subject may also be downloaded and displayed, and this may also be displayed in a different position without being superimposed on the subject 402. By doing so, it becomes possible for the user to obtain information for the entirety of the subject 401, which is hidden.

Although an example has been explained above in which the code information is supplementarily used at the time of detection, recognition, and display of the image, conversely, the recognition/detection results for the subject using the image may also be used as supplementary information for the code detection. For example, an example is given of a method in which the image is cropped at the size of subject detection box, and the code is detected by enlargement, and the like in order to facilitate the detection of the code. That is, the code detecting unit 103 may also detect the code based on the second information.

According to the present embodiment, it is possible to increase the precision of the subject detection and recognition by using the code information in the subject detection and recognition. In addition, it becomes possible to also display the entirety of a subject that is hidden by displaying appearance information that has been downloaded based on the code and the like.

### Third Embodiment

In the present embodiment, an explanation will be given of a method in which in a case in which a plurality of codes have been allocated to the same subject, an order of priority is assigned to the information. Note that explanations of configurations that are the same as the configurations in the First Embodiment will be omitted, and below, an explanation will be given that focuses on the portions that are different than the First Embodiment.

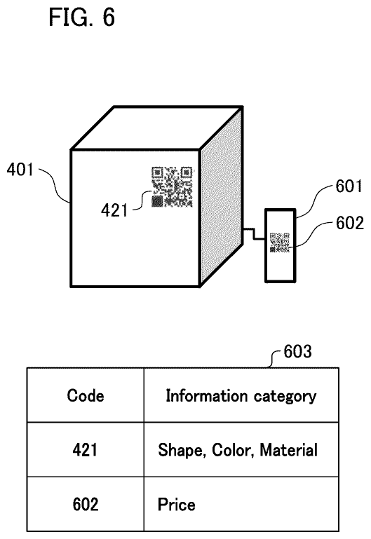

In FIGS. 6, 601 is a tag that has been allocated to the subject 401, and the code 602 is embedded into the tag 601. That is, in FIG. 6, the code 602 is also allocated to the subject 401 in addition to the code 421 that has been embedded into the subject itself.

In the present embodiment, the code includes a link to detailed information, as well as categories relating to the information for the link (information indicating categories). The table 603 shows an example of the categories (information categories) that have been embedded into the code. Although in the table 603, an example is shown of a case in which information indicating characteristics such as the shape, color, material, and the like of the subject is embedded into the code 421 as the categories, and the price information for the subject is embedded into the code 602 as the category, the present disclosure is not limited to the above-described combinations.

The code information acquisition unit 104 includes, for example, the information shown in the table 603 in the code information and outputs this to the information comparison unit 106. In the information comparison unit 106, an order of importance is allocated based on the contents of the code information that has been acquired, and the user interface 108 displays information with a high order of importance that has been obtained from the information comparison unit 106 in a first position on the display unit 130. Conversely, the user interface 108 may also display the information with a high order of importance in a format that is easy to catch the user's eye.

That is, the information comparison unit 106 functions as an information comparison unit configured to allocate an order of importance to the first information that has been acquired in a case in which correspondence has been performed for two or more codes within a specific settings area. In addition, the user interface 108 performs a display on the display unit by outputting the first information based on the order of importance.

In the present embodiment, a rule based method that prioritizes the information for the tag 601 over the subject 401 to which this is attached is used as the method for assigning the order of importance to the information. This is because the information for the subject 401 is generic, and few changes are made thereto, whereas there are many cases in which the tag information is allocated in a specific environment such as in-store, and the like, and therefore, there are many cases in which this is the allocation of information that should be prioritized.

In addition, when assigning the order of importance to the code information, the categories for the code information and the position information for the user themselves may also be used. The position information can be acquired by having a position information acquisition unit such as, for example, a GPS receiver, and the like. In addition, in a case in which it is able to be understood that the user is inside of a store, the order of importance is increased for code information that belongs to categories relating to a product such as the price, and the like. That is, the information comparison unit 106 allocates the order of priority based on the position information.

Conversely, the categories for code information that the user has selected are saved, and the user's preferred categories may also be learned. By doing so, it is possible to increase the order of importance for the user's preferred categories. Therefore, it becomes possible to provide information according to the individual tastes of the user. In addition, information indicating the order of importance may also be included in the code information.

According to the present embodiment, even in a case in which a plurality of codes have been allocated to the same subject, it becomes possible to display the appropriate information according to the conditions.

### Fourth Embodiment

In the present embodiment, an example will be explained in which in a case in which code information exists for which correspondence with a subject area has not been performed, the image recognition precision is increased by performing learning using this code information. Note that explanations of the configurations that are the same as the configurations in the First Embodiment will be omitted, and below, an explanation will be given that focuses on the portions that are different from the First Embodiment.

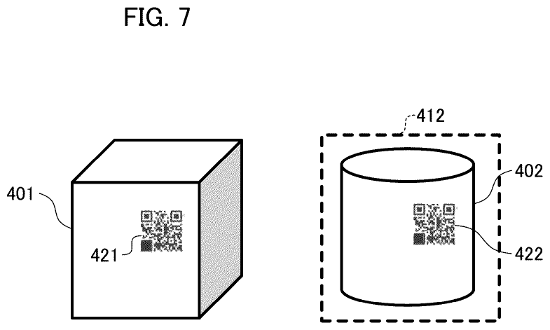

In a case in which the environment in which an image that was used in learning was acquired is different than the environment when the image recognition is actually performed, there is a possibility that the image recognition precision will be lowered. For example, this corresponds to a case in which a subject that was studied in an image that was captured during the daytime was image captured at dusk, and the like. At this time, there are cases in which even if the code is detected, correspondence cannot be performed with a subject area. An explanation of a specific example will be given with reference to FIG. 7.

Although in FIG. 7, correspondence has been performed for the subject area 412 and the code 422, a state is shown in which the subject 401 cannot be recognized in the image, and correspondence is not performed with any subject area for the code 421. At this time, a specific area that includes the code 421 is extracted from the image, and the image that has been extracted is made input data. A learning data set in which the code information that has been acquired from the code 421 is made correct data is input, and learning of a machine learning model is thereby performed. It thereby becomes possible to re-learn the subject 401 for which recognition failed.

For example, in the configuration of FIG. 1, the image information acquisition unit 105 may also have a machine learning-type image recognition function. The specific area including the code for which correspondence was not performed in the information comparison unit 106 may also be extracted in the image acquisition unit 101, and the subject detecting unit 102. A learning data set configured by the image data that has been extracted and the code information may also be input into the image information acquisition unit 105, and learning of a machine model may be thereby performed.

As has been explained above, according to the present embodiment, it becomes possible to increase the recognition rate for a subject for which recognition has failed by performing re-learning using the code information.

In the above described embodiment, examples of each type of variation have been considered. In addition, although in the First Embodiment to the Fourth Embodiment, explanations were given by limiting this to cases in which the subjects were objects, the present disclose can also be applied to cases in which codes have been allocated to humans, and animals. For example, in a sports usage, it is possible to embed tags in the uniforms of athletes in advance, and display information for the athletes.

The present disclosure can also be realized by processing in which a program that realizes one or more functions of the above-described embodiments is supplied to a system or apparatus via a network or a storage medium, and one or more processors in this system or a computer of the apparatus reads out and executes the program. In addition, the present disclosure may also be realized by a circuit (for example, an ASIC) that realizes one or more functions.

### Tther Embodiments

Above, although examples have been explained of favorable embodiments of the present disclosure, the present disclosure is not limited to these embodiments, and various changes and alterations may also be made within the gist thereof.

In addition, it may also be made such that a portion or the entirety of the control in each of the above-described embodiments is executed by supplying a computer program that realizes the functions of each of the above-described examples to the information processing apparatus 100, a system, and the like via a network or each type of storage medium. In addition, it may also be made such that a computer (additionally a CPU, an MPU, and the like) in this system and apparatus reads out and executes the program. In this case, the program and the storage medium on which this program has been stored configured the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, it is possible to acquire detailed information robustly and with high precision regarding a subject that will be made a target.

This application claims the benefit of Japanese Patent Application No. 2024-199849, filed Nov. 15, 2024 which is incorporated herein in its entirety.

What is claimed is:

1. An information processing apparatus comprising:
at least one memory storing instructions; and
at least one processor executing the stored instructions causing the information processing apparatus:
to set setting areas including subjects in an image;
to detect codes that have been allocated to the subjects;
to acquire first information corresponding to the codes;
to acquire second information corresponding to images within the setting areas;
to perform correspondence of the codes and the setting areas by comparing the first information and the second information; and
to output at least one of the first information and the second information based on the results of the correspondence.

2. The information processing apparatus according to claim 1, wherein the first information is information that is included in the codes, and information that is acquired from an external network based on the codes, and
wherein the second information is images of the setting areas, and information that is acquired from an external network based on images within the setting areas.

3. The information processing apparatus according to claim 1, wherein the codes are one or more from among two dimensional information that can be read using visible light, two dimensional information that can be read using non-visible light, three dimensional information that can be read using visible light, three dimensional information that can be read using non-visible light, and a tag that emits electromagnetic waves.

4. The information processing apparatus according to claim 1, wherein executing the stored instructions further causes the information processing apparatus:
to detect subject areas that are areas that include subjects in the image; and
to set the subject areas that have been detected as the setting areas.

5. The information processing apparatus according to claim 1, further comprising a display apparatus configured to display information,
wherein executing stored instructions by the processor further causes the information processing apparatus:
to acquire a position that has been designated by a user in the image; and
to display at least one of the first information and the second information on the display apparatus based on the position that has been acquired.

6. The information processing apparatus according to claim 5, wherein executing the stored instructions by the processor further causes the information processing apparatus to display area information indicating the setting area on the display apparatus, and after this, display the first information and the second information for which correspondence has been performed with the setting area that is indicated by the area information corresponding to the position that has been acquired.

7. The information processing apparatus according to claim 6, wherein executing the stored instructions by the processor further causes the information processing apparatus to display the area information in a case in which a number of the setting areas is below a predetermined threshold value.

8. The information processing apparatus according to claim 5, wherein executing the stored instructions by the processor further causes the information processing apparatus:
to detect a line of site of the user; and
to acquire the position based on the line of site that has been detected.

9. The information processing apparatus according to claim 1, wherein executing the stored instructions by the processor further causes the information processing apparatus to detect the codes based on the second information.

10. The information processing apparatus according to claim 4, wherein executing the stored instructions by the processor further causes the information processing apparatus to detect the subject areas based on the first information.

11. The information processing apparatus according to claim 1, wherein executing the stored instructions by the processor further causes the information processing apparatus to acquire at least one of appearance information for the subjects, and shape information for the subjects as the first information.

12. The information processing apparatus according to claim 1, wherein executing the stored instructions by the processor further causes the information processing apparatus to allocate an order of importance to the first information that has been acquired in a case in which correspondence has been performed with a specific setting area for two or more of the codes; and
to output the first information based on the order of importance.

13. The information processing apparatus according to claim 12, further comprising a position information acquisition apparatus configured to acquire position information for the information processing apparatus,
wherein executing the stored instructions by the processor further causes the information processing apparatus to allocate the order of importance based on the position information.

14. The information processing apparatus according to claim 12, wherein information indicating a category of the information relating to the subject to which the code has been allocated is included in the first information,
wherein executing the stored instructions by the processor further causes the information processing apparatus to allocate the order of importance based on the information indicating the category.

15. The information processing apparatus according to claim 1, wherein executing the stored instructions by the processor further causes the information processing apparatus to perform machine learning-type image recognition,
wherein the image recognition is performed by performing learning with a machine learning model by making the image and the first information inputs.

16. An information processing method executed by an information processing apparatus, the method comprising:
setting setting areas including subjects in an image;
detecting codes that have been allocated to the subjects;
acquiring first information corresponding to the codes;
acquiring second information corresponding to image information within the setting areas;
performing correspondence of the codes and the setting areas by comparing the first information and the second information; and
outputting at least one of the first information and the second information based on the results of the correspondence.

17. A non-transitory storage medium storing a program of an information processing apparatus, causing a computer to perform each step of an executed by an information processing apparatus, the method comprising:
setting setting areas including subjects in an image;
detecting codes that have been allocated to the subjects;
acquiring first information corresponding to the codes;
acquiring second information corresponding to image information within the setting areas;
performing correspondence of the codes and the setting areas by comparing the first information and the second information; and
outputting at least one of the first information and the second information based on the results of the correspondence.
